(19) United States
(12) Patent Application Publication
(10) Pub. No.: US 2013/0154257 A1
(43) Pub. Date: Jun. 20, 2013

(54) HOSE COUPLING

(71) Applicant: David Ault, Peoria, IL (US)

(72) Inventor: David Ault, Peoria, IL (US)

(73) Assignee: Caterpillar Inc., Peoria, IL (US)

(21) Appl. No.: 13/327,328

(22) Filed: Dec. 15, 2011

(51) Int. Cl. F16L 33/22; F16L 33/28

(52) U.S. Cl. 285/251; 285/242; 285/259; 285/256

(57) ABSTRACT

A hose coupling for attaching to the end of a hydraulic hose includes a shell member positioned about the free end of the hydraulic hose. A body member includes a first end and a second end. The second end of the body member is inserted through the shell member and into the inner diameter of the hydraulic hose. An encapsulated fastener is rotatably and slidably disposed about the body member and positioned between the first end and the shell member. The first end has a flange portion having a diameter greater than the diameter of the body member and contains a groove for receiving an o-ring. The o-ring is adapted for sealing connection to a hydraulic device.

### TECHNICAL FIELD

The present invention relates to improvements in a fluid coupling and more particularly to an o-ring face seal end for a hose-embracing shell and an inner tube coupling.

### BACKGROUND

In high pressure fluid systems used in aircraft, construction equipment and machine tools, hydraulic hoses are in extensive use for joining connecting fluid devices and powering peripherals or movable components of these machines. The hydraulic hoses are typically constructed of inner and outer layers of rubber or other elastomeric material with an intervening sleeve as of braided steel wire which imparts mechanical strength to the hose so as to be capable of withstanding repeated bending and pulling and of holding up to the internal high fluid pressures without bursting.

In these applications it is imperative to firmly attach the hose ends to a valve, manifold, or actuator. To this end various different designs for attaching a coupling to different types of hydraulic hose have been used. Some of the designs require the outer covering of the hose end to be stripped down to the braided wire and to provide a coupling at each end that grips the stripped hose end firmly between an internally ribbed or threaded socket and a nipple inserted in the hose end. Other designs utilize an internally ribbed or threaded socket and a nipple inserted in the hose end without stripping the outer layer of rubber away from the hose. These designs are respectively referred to as skive and no-skive methods for attaching the fluid coupling to the end of the hydraulic hose.

The terminating end or connector part of the coupling that attaches to the valve, manifold or actuator has many different and known variations in the industry as well. Many designs are known and have been standardized over the years such flanged o-ring seal styles, 37° and 45° degree flare ends, straight thread o-ring seal, and o-ring face seal designs. Two types of these hydraulic hose couplings are shown in U.S. Pat. No. 3,990,728 issued on Nov. 9, 1976 to the Gates Rubber Co. and U.S. Pat. No. 6,764,106 issued on Jul. 20, 2004 to Parker Hannifin Corp. Each of these couplings use different methods of attaching the coupling to the hose end and each show representative terminating ends that are used to connect to a variety of different fluid devices as described above.

However, each of the known type of couplings require multiple components and redundant manufacturing processes that add expense and increase the number of components and leak points for each fluid coupling joint. For example, flanged joints require four drilled and tapped holes at each joint with a two-piece flange that is positioned around the hydraulic hose coupling end. The four bolts are then tightened to draw the two-piece flange against the coupling end to compress an o-ring in the end of the hose coupling against the valve or manifold. Flare type connectors require a fitting be tightened to the fluid device so that a mating hose coupling can be tightened thereto. This is the same with straight thread o-ring and o-ring face seal connectors as well. Therefore what is needed is a hose coupling that reduces the number of components and the manufacturing costs of a hydraulic system as well as reducing the number of leak points and components that need to be tightened.

The present disclosure is directed to overcoming one or more of the problems as set forth above.

### SUMMARY OF THE INVENTION

In one aspect of the present disclosure, a hose coupling for attachment to the end of a hydraulic hose is described. The hose coupling has a body member with a first end portion, a second end portion, an axial length, and a bore centrally located therein and running the axial length of the body member. The bore providing a fluid communication passage there through. The first end has a flange portion having a diameter greater than the diameter of the body member and also contains a groove. The second end is adapted for insertion into the inner diameter of the hydraulic hose. An o-ring is positioned in the groove of the flange portion of the body member and adapted for sealing connection to an external device. A shell member with an annular recess positioned there through is adapted for receipt on the outer diameter of the free end of the hydraulic hose. The shell member supporting the body member and having a free end remote from the first end of the body member. An encapsulated fastener is rotatably and slidably positioned about the body member between the first end portion of the body member and the outer shell.

In yet another aspect of the present invention a hydraulic hose assembly is disclosed. The hydraulic hose assembly includes a length of hydraulic hose having an outer diameter and an inner diameter and used for conveyance of fluid under pressure. A first hose coupling is attached to the end of the hydraulic hose. The hose coupling has a body member with a first end portion, a second end portion, an axial length, and a bore centrally located therein and running the axial length of the body member. The bore providing a fluid communication passage there through. The first end has a flange portion having a diameter greater than the diameter of the body member and also contains a groove. The second end is adapted for insertion into the inner diameter of the hydraulic hose. An o-ring is positioned in the groove of the flange portion of the body member and adapted for sealing connection to an external device. A shell member with an annular recess positioned there through is adapted for receipt on the outer diameter of the free end of the hydraulic hose. The shell member supporting the body member and having a free end remote from the first end of the body member. An encapsulated fastener is rotatably and slidably positioned about the body member between the first end portion of the body member and the outer shell.

### BRIEF DESCRIPTION OF THE DRAWINGS

FIG. 1 is a longitudinal cross-sectional view of a hose coupling, according to the present disclosure;

FIG. 2 is a longitudinal cross-sectional view of alternate style of hose coupling; and

FIG. 3 is a cross-sectional view of an angled hose coupling of the type shown in FIG. 1

### DETAILED DESCRIPTION

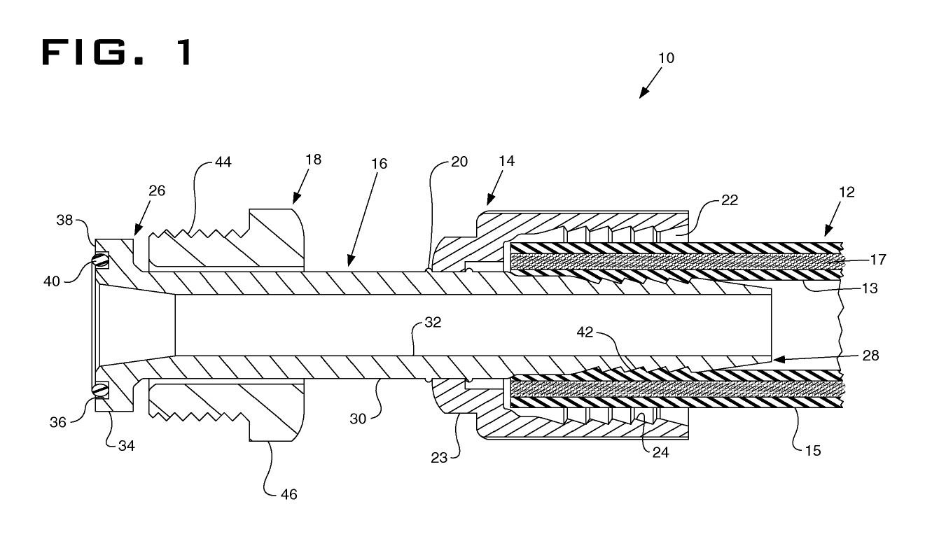

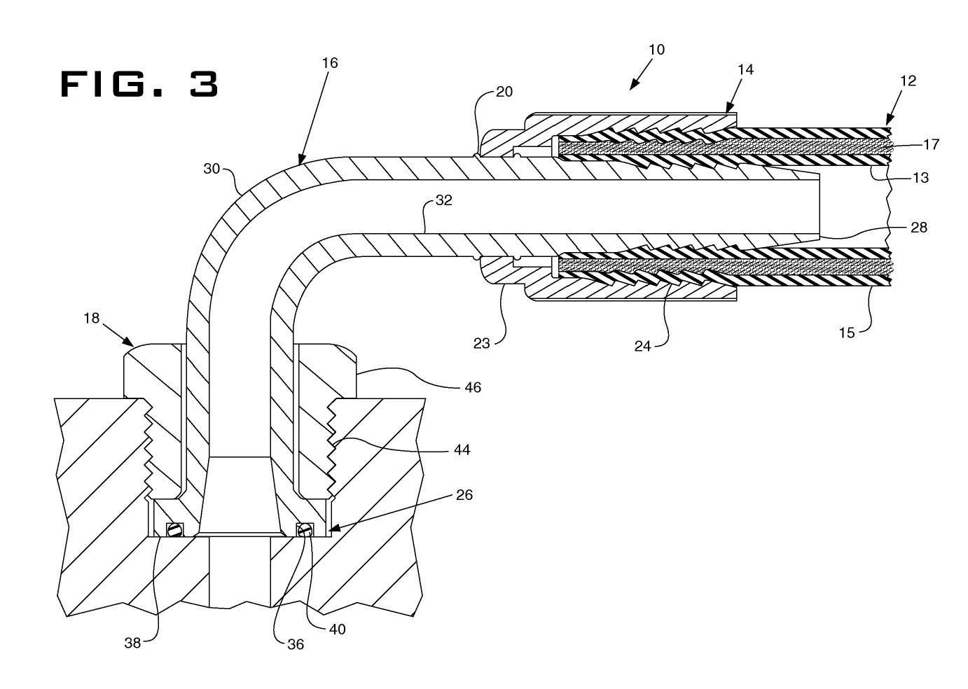

Referring now to the drawings and particularly to FIG. 1, there is shown a longitudinal cross-section of a hydraulic hose coupling or coupling 10 shown positioned about a free end of hydraulic hose 12. Hydraulic hose 12 as is commonly known in the industry has an inner diameter 13 and an outer diameter 15 made from layers of rubber or other elastomeric material with an intervening sleeve 17 as of braided steel wire. The hose coupling 10 is a multi-piece assembly having three main components all of which are generally constructed of metal such as steel. Hose coupling 10 includes an outer shell 14 positioned about a body member 16. An encapsulated nut 18 is rotatably and slidably positioned about the body member 16. In FIG. 1 body member 16 is shown as being straight, although body member 16 can take any desired angle or straight orientation, e.g. a 90° elbow, as shown in FIG. 3, or other angular variations in between. Outer shell 14 can take on a variety of different configurations that can be used to attach to the exterior of hydraulic hose 12 in different manners.

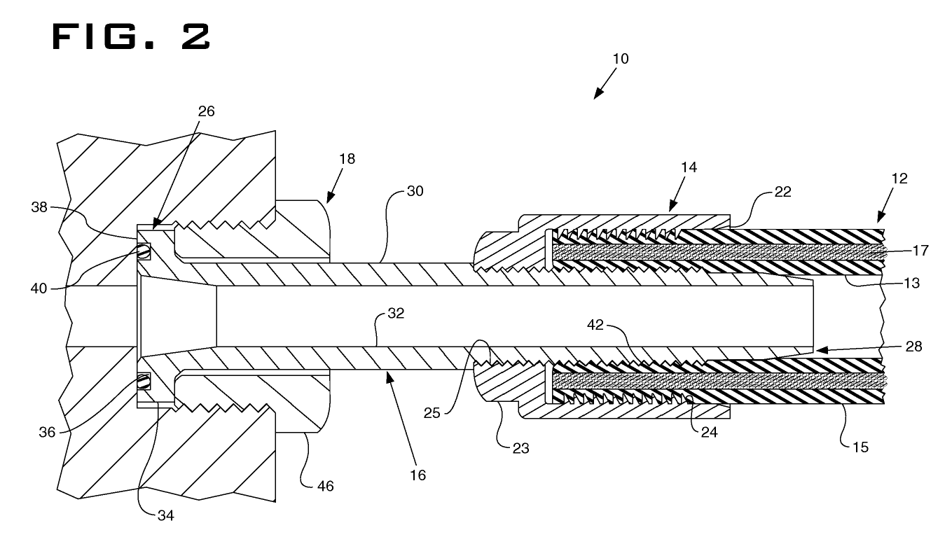

For example, the hose coupling 10 shown in FIG. 1 is a single use coupling that can be permanently connected to the end of hydraulic hose 12. Hose coupling 10 shown in FIG. 1 is ready for a crimping or swaging operation, but the outer shell 14 has not yet been swaged in place to the hydraulic hose 12. The outer shell 14 for this type of hose coupling 10 is secured in some fashion to the body member 16 in some fashion, such as by undulations 20 in the body member 16 as shown in FIGS. 1 and 3, or can be rigidly secured as by welding or machining In this manner the body member 16 is supported within the outer shell 14. The outer shell 14 includes an annular recess 22 that has a plurality of projections 24 extending radially inward towards the body member 16 at one end as seen in FIGS. 1-3. The plurality of projections 24 aid in holding onto the outer diameter 15 of the hydraulic hose 12 in a final assembled state. Outer shell includes a receiving portion 23 to aid in assembly, or tightening to a hydraulic device. The outer shell may also include an internal threaded portion 25 opposite the projections 24 so as to support the body member 16 in a reusable hose coupling 10 as seen in FIG. 2. The plurality of projections 24 are configured to grip the exterior of the hydraulic hose 12 after a crimping operation is performed so as to maintain a clamping force to hold the hose coupling 10 in place in a single use hose coupling 10. This type of crimping operation is well known in the industry and need not be described in greater detail. The plurality of projections 24 shown in FIG. 2 are actually a helical configuration in the reusable hose coupling that is threaded to the exterior of the free end of the hydraulic hose 12 and used for the same purpose of maintaining the holding force.

The body member 16 has a first end 26, a second end 28, an axial stem 30 positioned between the first and second ends 26,28 and a bore 32 extending from the first end 26 to the second end 28. A flange portion 34 is fixedly connected or formed on the first end 26 of the body member 16. Flange portion 34 has a groove 36 positioned in a face 38 as shown in FIG. 1. The groove 36 is sized so as to receive an o-ring 40 of an appropriate diameter and cross sectional thickness to provide a seal when the encapsulated nut 18 is tightened into the corresponding hydraulic device such as a manifold, valve, or actuator as can be seen in FIGS. 2 and 3. Body member 16 also includes a plurality of protrusions 42 disposed about the outer circumference of the axial stem 30 near the second end 28. The protrusions 42 may be a series of longitudinally spaced saw teeth or a helical thread as shown in FIG. 2. The protrusions 42 aid in holding the body member 16 in a fixed relationship to the inner diameter 13 of the free end of the hydraulic hose 12 after assembly for both the single use or the reusable hose coupling 10.

The encapsulated nut 18 that is slidably and rotatably positioned about the first end 26 of the body member 16 and the outer shell 14. The encapsulated nut 18 has a threaded portion 44 positioned on the outer circumference and a receiving portion 46 positioned on the other end. The threaded portion 44 may be left or right handed, inch or metric and may conform to a standard thread designation such as SAE, JIS, DIN, ISO, NH, NPSH, etc. but the threaded portion 44 need not be limited to these designations. The threaded portion 44 of the encapsulated nut 18 is appropriately sized for connecting to the hydraulic device such as a manifold, valve, or actuator for the type of machinery and purpose as stated above. The receiving portion 46 can take on a variety of configurations so that aid in tightening the hose coupling 10 to a hydraulic device such as a manifold, valve or actuator. The receiving portion 46 may have wrench flats or other configurations so that different types of spanner wrenches may be used for example hook-type or pin-type can be used. The hose coupling 10 and the hydraulic hose 12 may rotate or move with the input torque from a wrench on the encapsulated nut 18 during the tightening process, unless the hose coupling 10 is held fixed. Since the majority of shell member 14 is rounded on the single use hose coupling, it is difficult to hold in place. For this reason, the receiving portion 23 may also include wrench flats similar to the receiving portion 46 on the encapsulated nut 18 so that the installer can hold hose coupling 10 in place, i.e. against rotation, during the tightening process.

### INDUSTRIAL APPLICABILITY

The hose coupling 10 of the present disclosure as described above can be attached to the free end of a hydraulic hose 12 in number of known different methods. First, there is the single use method were the body member 16 is inserted into the inner diameter 13 of the hydraulic hose 12. In this method the outer shell 14 is crimped into position by a machine that compresses the outer shell 14 into fixed relationship with the outer diameter 15 of the hydraulic hose 12. Then there is the reusable configuration were the outer shell 14 is threaded onto the outer diameter 15 of the hydraulic hose 12. The body member 16 is then threaded first into the end of the outer shell 14 and then into the inner diameter 13 of the hydraulic hose 12. Other methods or variations of attachment methods should be readily apparent to those skilled in the art such as skive and no skive styles etc.

The advantage to the present disclosure is the method of connecting the hose coupling 10 to another hydraulic device such as a manifold, valve or actuator. All that is required of the present design is to tighten the encapsulated nut 18 into the mating device. As the flange portion 34 of the first end 26 of the body member is drawn close to the flat bottom of the threaded inlet or outlet of the hydraulic device the encapsulated nut 18 makes contact with the flange portion 34. Upon continued tightening of the encapsulated nut 18 the flange portion 34 is pushed towards the flat bottom of the hydraulic device causing the o-ring 40 to compress into sealing relationship with the bottom of the port and the face 38 of the flange portion 34 is seated therewith. The present design therefore requires only one aperture be machined on the device that the connection is being made with. The hydraulic hose 12 and the hose coupling 10 can be positioned by rotating the body member 16 relative to the encapsulated nut 18 during the connection process until the desired orientation is achieved just prior to the final tightening takes place. The present design reduces the number of leak points, the number of components and the required machining that takes place for every hose coupling 10 that takes place in the equipment

Other aspects of this disclosure can be obtained from a study of the drawings, the disclosure and the appended claims.

What is claimed is:

1. A hose coupling for attachment to the end of a hydraulic hose, the hydraulic hose having an outer diameter and an inner diameter and used for conveyance of fluid under pressure comprising:
a body member having a first end portion, a second end portion, an axial length, and a bore centrally located therein and extending the axial length of the body member, the bore providing a fluid communication passage there through, the first end having a flange portion having a diameter greater than the diameter of the body member, the flange portion containing a groove, the second end adapted for insertion into the inner diameter of the hydraulic hose;
an o-ring being positioned in the groove of the flange portion of the body member, the o-ring being adapted for sealing connection to an external device,
a shell member having an annular recess positioned there through being adapted for receipt of the outer diameter of the free end of the fluid hose, the shell member supporting the body member and having a free end remote first end of the body member; and
an encapsulated fastener being rotatably and slidably positioned about the body member between the first end portion and the outer shell.

2. The hose coupling set forth in claim 1 wherein the annular recess of the outer shell includes a plurality of projections positioned therein, the plurality of projections extend radially inwardly toward the body member so that upon positioning about the free end of the hydraulic hose assist in maintaining connection with the free end of hydraulic hose

3. The hose coupling set forth in claim 2 wherein the plurality of projections in the annular recess of the shell member form a helical member that thread onto the free end of the hydraulic hose and the second end portion of body member has threads formed on the exterior thereof so as to thread into the shell member and into the inner diameter of the hydraulic hose.

4. The hose coupling set forth in claim 2 wherein the plurality of projections in the annular recess of the shell member clamp onto the outer diameter of free end of the hydraulic hose when a swaging force is applied to the outer shell during assembly.

5. The hose coupling set forth in claim 4 wherein the second end of the body member includes a series of protrusions positioned thereon so as to assert a force on the inner diameter of the hydraulic hose when a swaging force is applied to the outer shell during assembly.

6. The hose coupling set forth in claim 1 wherein the encapsulated nut includes external threads for mating with one of a DIN, JIS, ISO, SAE, NH and NPSH.

7. The hose coupling set forth in claim 1 wherein the body member includes one of a straight and an angled configuration.

8. A hydraulic hose assembly comprising:
a length of hydraulic hose having an outer diameter and an inner diameter and used for conveyance of fluid under pressure;
a first hose coupling for attachment to the end of the hydraulic hose, the hose coupling includes;
a body member having a first end portion, a second end portion, an axial length, and a bore centrally located therein and extending the axial length of the body member, the bore providing a fluid communication passage there through, the first end having a flange portion having a diameter greater than the diameter of the body member, the flange portion containing a groove, the second end adapted for insertion into the inner diameter of the hydraulic hose;
an o-ring being positioned in the groove of the flange portion of the body member, the o-ring being adapted for sealing connection to an external device,
a shell member having an annular recess positioned there through being adapted for receipt of the outer diameter of the free end of the fluid hose, the shell member supporting the body member and having a free end remote first end of the body member; and
an encapsulated fastener being rotatably and slidably positioned about the body member between the first end portion and the outer shell.

9. The hydraulic hose assembly set forth in claim 8 wherein the annular recess of the outer shell includes a plurality of projections positioned therein, the plurality of projections extend radially inwardly toward the body member so that upon positoning about the free end of the hydraulic hose the projections assist in maintaining connection with the free end of hydraulic hose

10. The hydraulic hose assembly set forth in claim 9 wherein the plurality of projections in the annular recess of the shell member form a helical member that thread onto the free end of the hydraulic hose and the second end portion of body member has threads formed on the exterior thereof so as to thread into the shell member and into the inner diameter of the hydraulic hose.

11. The hydraulic hose assembly set forth in claim 9 wherein the plurality of projections in the annular recess of the shell member clamp onto the outer diameter of free end of the hydraulic hose when a swaging force is applied to the outer shell during assembly.

12. The hydraulic hose assembly set forth in claim 11 wherein the second end of the body member includes a series of protrusions positioned thereon so as to assert a force on the inner diameter of the hydraulic hose when a swaging force is applied to the outer shell during assembly.

13. The hydraulic hose assembly set forth in claim 8 wherein the encapsulated nut includes external threads for mating with one of a DIN, JIS, ISO, SAE, NH and NPSH.

14. The hydraulic hose assembly set forth in claim 8 wherein the body member includes one of a straight and an angled configuration.

15. The hydraulic hose assembly set forth in claim 8 including a second hose coupling positioned on the length of hydraulic hose opposite the first hose coupling.
